(19) United States
(12) Patent Application Publication
(10) Pub. No.: US 2021/0229688 A1
(43) Pub. Date: Jul. 29, 2021

(54) VEHICLE CONTROL METHOD, VEHICLE CONTROLLER, AND SERVER

(71) Applicant: TOYOTA JIDOSHA KABUSHIKI KAISHA, Toyota-shi (JP)

(72) Inventors: Yosuke HASHIMOTO, Nagakute-shi (JP); Akihiro KATAYAMA, Toyota-shi (JP); Yuta OSHIRO, Nagoya-shi (JP); Kazuki SUGIE, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 17/128,505

(22) Filed: Dec. 21, 2020

(30) Foreign Application Priority Data
Jan. 29, 2020 (JP) 2020-012546

(51) Int. Cl. B60W 50/06

(52) U.S. Cl. CPC B60W 50/06; B60W 2050/0077; B60W 2556/45; B60W 2555/20

(57) ABSTRACT

A vehicle control method applied to a system including a vehicle controller and a server configured to communicate with the vehicle controller is provided. The vehicle control method includes executing a state obtaining process that obtains a state of a vehicle, executing an operating process that operates an electronic device based on the state of the vehicle and operating data, executing an environment information obtaining process that obtains environment information, executing an environment determination process that determines whether traveling environment indicated by the environment information is changed, and when the environment determination process determines that the traveling environment is changed, executing a data changing process that causes the vehicle controller to obtain the operating data corresponding to the environment information from the server and causes a first storage device to store the operating data.

### BACKGROUND

### 1. Field

The following description relates to a vehicle control method, a vehicle controller, and a server.

### 2. Description of Related Art

Japanese Laid-Open Patent Publication No. 2016-6327 describes an example of a controller that operates a throttle valve, which is an operating unit of an internal combustion engine mounted on a vehicle, based on a value obtained by processing an operation amount (depression) of an accelerator pedal through a filter.

The filter needs to set an appropriate operation amount of the throttle valve of the internal combustion engine mounted on the vehicle in accordance with the operation amount of the accelerator pedal. Therefore, one skilled in the art typically needs to perform a large amount of work for adaptation of the filter. Typically, one skilled in the art performs a large amount of work for adaptation of, for example, an operating amount of an electronic device installed in a vehicle in accordance with the state of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the present disclosure and their operation and advantages are as follows.

Aspect 1. An aspect of the present disclosure provides a vehicle control method applied to a system including a vehicle controller arranged on a vehicle and a server configured to communicate with the vehicle controller. The vehicle controller includes a first storage device configured to store operating data used when operating an electronic device of the vehicle. The vehicle control method includes: executing a state obtaining process that obtains a state of the vehicle based on a detection value of a sensor arranged on the vehicle with processing circuitry; executing an operating process that operates the electronic device based on the state of the vehicle obtained in the state obtaining process and the operating data stored in the first storage device with the processing circuitry; executing an environment information obtaining process that obtains environment information with the processing circuitry, the environment information being information related to a traveling environment, and the traveling environment being an environment in which the vehicle is traveling; executing an environment determination process that determines whether the traveling environment indicated by the environment information obtained in the environment information obtaining process is changed with the processing circuitry; and when the environment determination process determines that the traveling environment is changed, executing a data changing process that causes the vehicle controller to obtain the operating data corresponding to the environment information from the server and causes the first storage device to store the operating data with the processing circuitry.

In this configuration, when it is determined that the traveling environment indicated by environment information of the vehicle is changed, the vehicle controller obtains operating data corresponding to the environment information from the server and stores the operating data in the first storage device. Subsequently, the electronic device of the vehicle is operated based on the operating data that is newly stored in the first storage device. That is, in the configuration, the vehicle is provided with the operating data corresponding to the current traveling environment of the vehicle, so that vehicle control is executed in accordance with the current traveling environment.

Aspect 2. In the vehicle control method according to aspect 1, the environment information may include information related to an area in which the vehicle is traveling. The environment determination process may include a process that determines that the traveling environment is changed when the area in which the vehicle is traveling, indicated by the environment information, is changed.

In this configuration, when it is determined that the area in which the vehicle is traveling is changed, operating data corresponding to the new area in which the vehicle is traveling is provided from the server to the vehicle controller. As a result, vehicle control is executed in accordance with the operating data corresponding to the current travel area.

Aspect 3. In the vehicle control method according to aspect 1 or 2, the environment information may include information related to a current season. The environment determination process may include a process that determines that the traveling environment is changed when the season indicated by the environment information is changed.

In this configuration, when it is determined that the season is changed, operating data corresponding to the new season is provided from the server to the vehicle controller. As a result, vehicle control is executed in accordance with the operating data corresponding to the current season.

Aspect 4. In the vehicle control method according to any one of aspects 1 to 3, the operating data may include relationship specifying data specifying a relationship between the state of the vehicle and an action variable. The action variable is related to operation of the electronic device. The relationship specifying data is obtained by executing: a process that assigns a reward based on the state of the vehicle when the electronic device is operated in accordance with a value of the action variable determined by the state of the vehicle and the relationship specifying data, the reward assigned when a property of the vehicle meets a predetermined criterion being greater than the reward assigned when the property of the vehicle does not meet the predetermined criterion; and a process that updates the relationship specifying data using the state of the vehicle when the electronic device is operated, the value of the action variable used for operation of the electronic device, and the reward corresponding to the operation as inputs to a predetermined update mapping. The update mapping may be configured to output the relationship specifying data that is updated so that an expected return of the reward is increased when the electronic device is operated in accordance with the relationship specifying data.

This configuration calculates a reward corresponding to operation of the electronic device, so that what type of reward is obtained by the operation is acknowledged. Based on the reward, the relationship specifying data is updated by the update mapping in accordance with reinforcement learning, so that the relationship between the state of the vehicle and the action variable is appropriately set during traveling of the vehicle. Thus, the relationship between the state of the vehicle and the action variable is adjusted during traveling of the vehicle. That is, appropriate vehicle control is executed by updating the relationship specifying data.

Aspect 5. In the vehicle control method according to any one of aspects 1 to 3, the operating data may include control mapping data generated based on relationship specifying data specifying a relationship between the state of the vehicle and an action variable. The action variable is related to operation of the electronic device. The relationship specifying data may be obtained by executing: a process that assigns a reward based on the state of the vehicle when the electronic device is operated in accordance with a value of the action variable determined by the state of the vehicle and the relationship specifying data, the reward assigned when a property of the vehicle meets a predetermined criterion being greater than the reward assigned when the property of the vehicle does not meet the predetermined criterion; and a process that updates the relationship specifying data using the state of the vehicle when the electronic device is operated, the value of the action variable used for operation of the electronic device, and the reward corresponding to the operation as inputs to a predetermined update mapping. The update mapping may be configured to output the relationship specifying data that is updated so that an expected return of the reward is increased when the electronic device is operated in accordance with the relationship specifying data.

In this configuration, control mapping data corresponding to the current environment information is provided from the server to the vehicle controller. The control mapping data is stored in the first storage device, and the electronic device of the vehicle is operated based on the control mapping data. Thus, appropriate vehicle control is executed on the vehicle in accordance with the current traveling environment.

Aspect 6. In the vehicle control method according to any one of aspects 1 to 5, the server may include a second storage device configured to store multiple of the operating data corresponding to pieces of the environment information that are assumed. The data changing process may include a data selection process that selects operating data that corresponds to the environment information obtained in the environment information obtaining process from the multiple of the operating data stored in the second storage device, a transmission process that transmits the operating data selected in the data selection process to the vehicle controller, and a data storing process that causes the first storage device to store the operating data transmitted from the server in the transmission process.

In this configuration, operating data corresponding to the environment information is selected from the multiple operating data stored in the second storage device of the server, and the operating data is transmitted from the server to the vehicle controller.

Aspect 7. In the vehicle control process according to aspect 4, the vehicle may be a first vehicle that is one of vehicles configured to communicate with the server. The data changing process may include: a vehicle search process that searches, when the traveling environment indicated by the environment information of the first vehicle is changed, for a second vehicle that is traveling in the traveling environment that is same as the changed traveling environment of the first vehicle; a changing data obtaining process that causes the server to obtain the relationship specifying data of the second vehicle searched in the vehicle search process from the second vehicle; a transmission process that transmits the relationship specifying data of the second vehicle obtained by the server in the changing data obtaining process to the first vehicle; and a data storing process that causes the first storage device of the first vehicle to store the operating data of the second vehicle transmitted from the server to the first vehicle in the transmission process.

In this configuration, when it is determined that the traveling environment of the first vehicle is changed, a second vehicle traveling in the same traveling environment as the first vehicle is searched for. The operating data of the searched second vehicle is provided to the first vehicle via the server. Thus, appropriate vehicle control is executed on the first vehicle in accordance with the current traveling environment.

Aspect 8. In the vehicle control method according to any one of aspects 1 to 7, the processing circuitry may include a first execution device arranged on the vehicle and a second execution device arranged on the server. The vehicle control method may further include executing the state obtaining process and the operating process with the first execution device, executing the environment information obtaining process with the first execution device or the second execution device, and executing the data changing process with the first execution device and the second execution device.

Aspect 9. An aspect of the present disclosure provides a vehicle controller that includes the first execution device and the first storage device according to aspect 8.

Aspect 10. An aspect of the present disclosure provides a server that includes the second execution device according to aspect 8.

Other features and aspects will be apparent from the following detailed description, the drawings, and the claims.

### BRIEF DESCRIPTION OF THE DRAWINGS

FIG. 1 is a diagram showing a controller and a drive system in a first embodiment.

FIG. 2 is a schematic block diagram showing the configuration of the controller and the configuration of a server communicating with vehicles.

FIG. 3 is a diagram showing a system configured to generate map data in the first embodiment.

FIG. 4 is a flowchart showing the procedures of a process executed by the system in the first embodiment.

FIG. 5 is a flowchart showing details of a learning process in the first embodiment.

FIG. 6 is a flowchart showing the procedures of a process executed by the controller when operating an electronic device of the vehicle.

FIG. 7 is a flowchart showing the procedures of a process executed by the controller when rewriting data stored in a storage device of the controller.

FIG. 8 is a flowchart showing the procedures of a process executed by the server when providing a vehicle with map data corresponding to the traveling environment of the vehicle.

FIG. 9 is a schematic block diagram showing the configuration of a controller and the configuration of a server in a second embodiment.

FIG. 10 is a flowchart showing the procedures of a process executed by the controller when operating an electronic device of the vehicle.

FIG. 11 is a schematic block diagram showing the configuration of a controller and the configuration of a server in a third embodiment.

FIG. 12 is a flowchart showing the procedures of a process executed by the server when providing a vehicle with map data corresponding to the traveling environment of the vehicle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

A first embodiment of a vehicle control method, a vehicle controller, and a server will be described below with reference to the drawings.

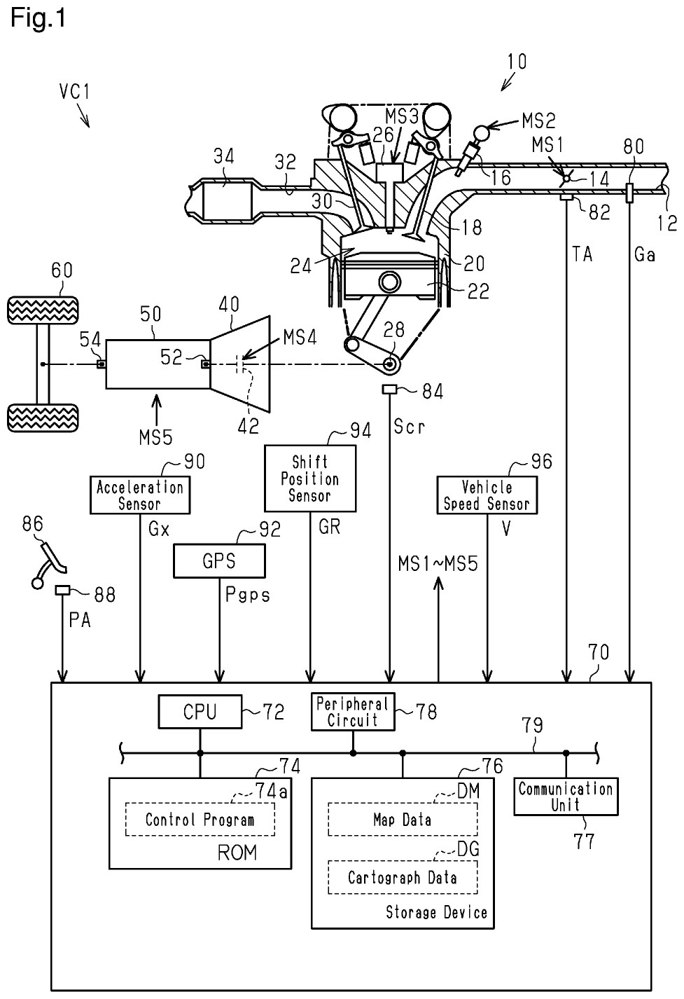

FIG. 1 shows the configuration of a controller 70, that is, a vehicle controller, and the configuration of a drive system of a vehicle VC1 including the controller 70.

As shown in FIG. 1, the vehicle VC1 includes an internal combustion engine 10 as a propulsive force generator of the vehicle VC1. The internal combustion engine 10 includes an intake passage 12 provided with a throttle valve 14 and a fuel injection valve 16, which are sequentially arranged from the upstream side. When an intake valve 18 is open, air drawn into the intake passage 12 and fuel injected from the fuel injection valve 16 flow into a combustion chamber 24 defined by a cylinder 20 and a piston 22. In the combustion chamber 24, a mixture of the air and the fuel is burned by spark discharge of an ignition device 26, and energy generated by the combustion is converted into rotational energy of a crankshaft 28 via the piston 22. The burned air-fuel mixture is discharged to an exhaust passage 32 as exhaust when an exhaust valve 30 is open. The exhaust passage 32 is provided with a catalyst 34 used as a post-processing device that purifies the exhaust.

The crankshaft 28 is configured to be mechanically coupled to an input shaft 52 of a transmission 50 by a torque converter 40 including a lock-up clutch 42. The transmission 50 is a device that variably sets the transmission ratio, that is, the ratio of rotation speed of the input shaft 52 to rotation speed of an output shaft 54. The output shaft 54 is mechanically coupled to drive wheels 60.

The controller 70 controls the internal combustion engine 10 and operates operating units of the internal combustion engine 10 such as the throttle valve 14, the fuel injection valve 16, and the ignition device 26 to control their control aspects such as torque and an exhaust component ratio. The controller 70 also controls the torque converter 40 and operates the lock-up clutch 42 to control the engagement state of the lock-up clutch 42. The controller 70 also controls the transmission 50 and operates the transmission 50 to control the transmission ratio, which is the control aspect of the transmission 50. FIG. 1 shows operating signals MS1, MS2, MS3, MS4, and MS5 of the throttle valve 14, the fuel injection valve 16, the ignition device 26, the lock-up clutch 42, and the transmission 50, respectively. The operating units that receive the operating signals MS1 to MS5 from the controller 70 are each an example of an “electronic device.”

To control the control aspects, the controller 70 refers to an intake air amount Ga that is detected by an airflow meter 80, a throttle opening degree TA, which is an opening degree of the throttle valve 14 detected by a throttle sensor 82, and an output signal Scr of a crank angle sensor 84. In addition, the controller 70 refers to an accelerator operation amount PA, which is a depression amount of an accelerator pedal 86 detected by an accelerator sensor 88, and an acceleration rate Gx in the front-rear direction of the vehicle VC1 detected by an acceleration sensor 90. The controller 70 also refers to position data Pgps obtained from a global positioning system (GPS 92), a transmission ratio GR detected by a shift position sensor 94, and a vehicle speed V detected by a vehicle speed sensor 96.

The controller 70 includes a central processing unit (CPU) 72, a read only memory (ROM) 74, a storage device 76, which is an electrically rewritable nonvolatile memory, a communication unit 77, and a peripheral circuit 78, which are configured to communicate with each other through a local network 79. The peripheral circuit 78 includes a circuit that generates a clock signal regulating an internal operation, a power supply circuit, a reset circuit, and the like.

The ROM 74 stores a control program 74a. The storage device 76 stores map data DM and cartograph data DG. The map data DM uses a throttle opening degree instruction value TA*, that is, an instruction value of the throttle opening degree TA, and a transmission ratio instruction value GR*, that is, an instruction value of the transmission ratio GR, as output variables. The map data DM uses the present transmission ratio GR, the vehicle speed V, and time series data of the accelerator operation amount PA as input variables and uses the throttle opening degree instruction value TA* and the transmission ratio instruction value GR* as output variables.

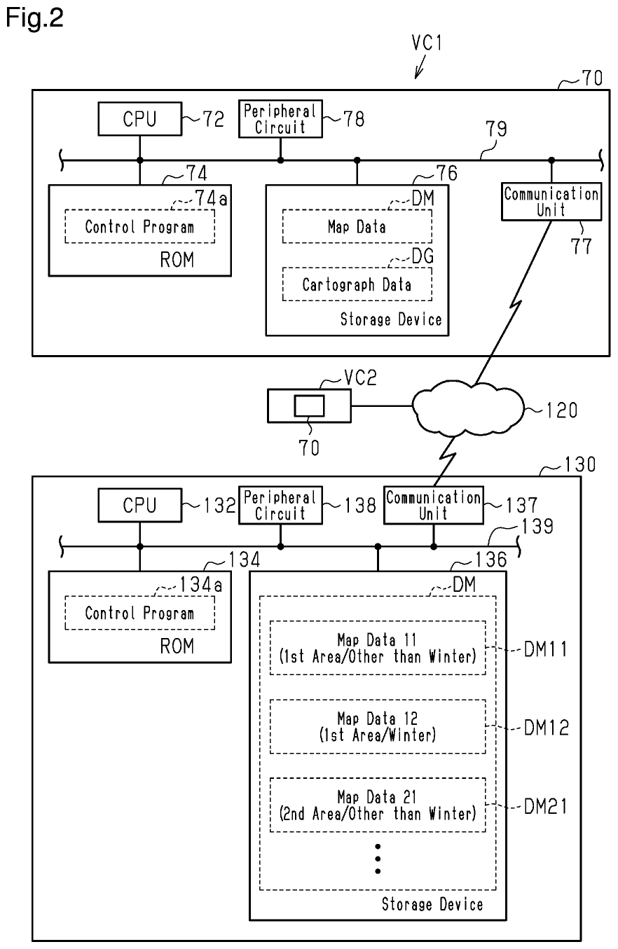

As shown in FIG. 2, the communication unit 77 is a device configured to communicate with a server located outside the vehicle via an external network 120 of the vehicle VC1.

The server 130 analyzes data transmitted from vehicles VC1, VC2, . . . . The server 130 includes a CPU 132, a ROM 134, a storage device 136, that is, an electrically rewritable nonvolatile memory, a peripheral circuit 138, and a communication unit 137 that are configured to communicate with each other through a local network 139. The ROM 134 stores a control program 134a. The storage device 136 stores the map data DM. In the present embodiment, the storage device 136 stores map data DM11, DM12, DM21, . . . as the map data DM.

More specifically, the map data DM includes multiple map data prepared for multiple areas. For example, the map data DM11 and DM12 are map data obtained by reinforcement learning based on an assumption that the vehicles travel in a first area AR1. The map data DM21 is map data obtained by reinforcement learning based on an assumption that the vehicles travel in a second area AR2 that differs from the first area AR1. Although not shown in the drawings, map data prepared for a third area that differs from the areas AR1 and AR2 is also obtained by reinforcement learning based on an assumption that the vehicles travel in the third area.

For example, when the property of fuel supplied to the vehicles from a fueling station in the first area AR1 is referred to as a first property, the second area AR2 refers to an area in which fuel having a second property that differs from the first property is supplied to the vehicles. That is, in the present embodiment, the areas are divided based on the difference in the property of fuel supplied to the vehicles from the fueling stations.

In addition, in the present embodiment, map data is prepared for each season. For example, in the map data DM11 and DM12 used for the first area AR1, the map data DM11 is obtained by reinforcement learning based on an assumption that the vehicles travel in the first area AR1 in seasons excluding winter. The map data DM12 is obtained by reinforcement learning based on an assumption that the vehicles travel in the first area AR1 in winter. In multiple map data used for the second area AR2, the map data DM21 is obtained by reinforcement learning based on an assumption that the vehicles travel in the second area AR2 in seasons excluding winter. Although not shown in the drawings, map data that is learned by reinforcement learning based on an assumption that the vehicles travel in the second area AR2 in winter is also prepared.

In each of the areas AR1 and AR2, the property of fuel supplied to the vehicles from fueling stations is changed in accordance with seasons. For example, the fuel supplied to the vehicles from the fueling station differs in volatility between when the ambient temperature is low like winter and when the ambient temperature is not so low like seasons excluding winter.

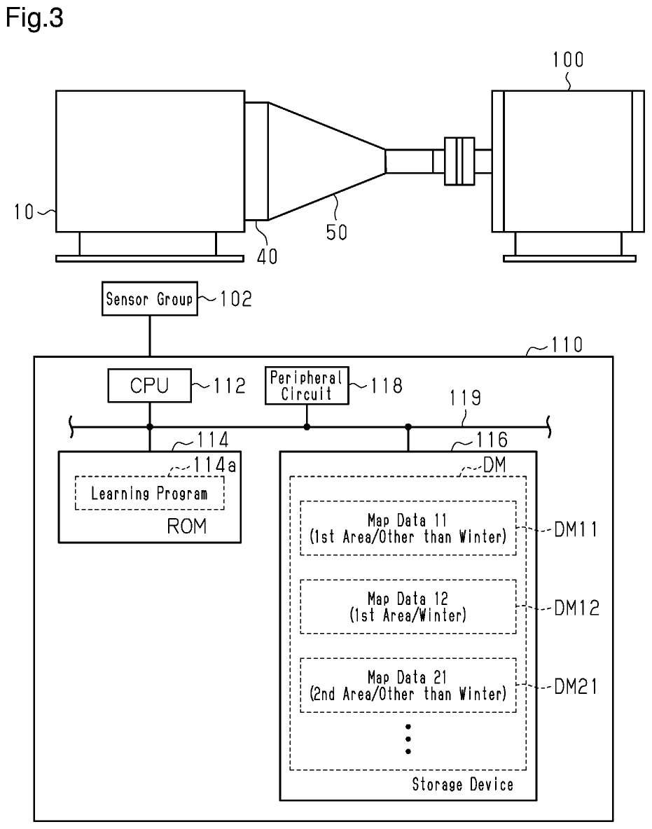

FIG. 3 shows a system configured to generate the map data DM.

In the system shown in FIG. 3, the crankshaft 28 of the internal combustion engine 10 is mechanically coupled to a dynamometer 100 by the torque converter 40 and the transmission 50. While the internal combustion engine 10 is running, a sensor group 102 detects various state variables, and the detection results are input to a generator 110 that is a computer configured to generate the map data DM. The sensor group 102 includes the sensors mounted on the vehicle VC1 shown in FIG. 1.

The generator 110 includes a CPU 112, a ROM 114, a storage device 116, which is an electrically rewritable nonvolatile memory, and a peripheral circuit 118 that are configured to communicate with each other through a local network 119. The map data DM is stored in the storage device 116. In the present embodiment, the storage device 116 stores the map data DM11, DM12, DM21, . . . as the map data DM. The ROM 114 stores a learning program 114a that learns relationship specifying data DR (described later) through reinforcement learning.

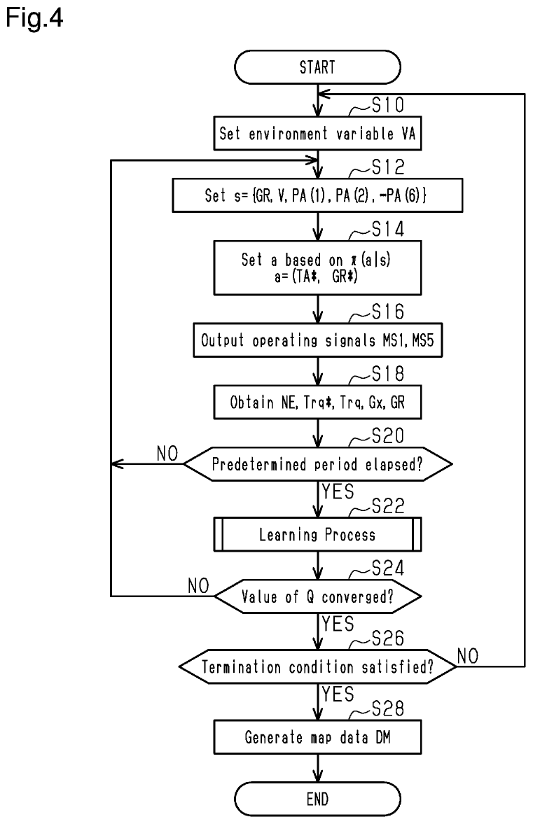

FIG. 4 shows the procedures of a process executed by the generator 110. A series of the processes shown in FIG. 4 is implemented by the CPU 112 executing the learning program 114a stored in the ROM 114. In the following description, the step number of each process is represented by a numeral provided with an “S” prefix.

In the series of the processes shown in FIG. 4, the CPU 112 sets a value of an environment variable VA (S10). The environment variable VA is used to determine which one of relationship specifying data DR11, DR12, DR21, . . . is learned. More specifically, the relationship specifying data DR that is learned is changed by changing the environment variable VA. For example, when the environment variable VA is “11,” the relationship specifying data DR11 is learned. The relationship specifying data DR11 is included in the map data for the first area AR1 and is used to generate the map data DM11, which is used in seasons excluding winter. For example, when the environment variable VA is “12,” the relationship specifying data DR12 is learned. The relationship specifying data DR12 is included in the map data for the first area AR1 and used to generate the map data DM12, which is used in winter. For example, when the environment variable VA is “21,” the relationship specifying data DR21 is learned. The relationship specifying data DR21 is included in the map data for the second area AR2 and is used to generate the map data DM21, which is used in seasons excluding winter. For example, when the environment variable VA is “22,” relationship specifying data that is included in the map data for the second area AR2 and used to generate map data used in winter is learned. For example, when the environment variable VA is “31,” relationship specifying data that is included in the map data for the third area and used to generate map data used in seasons excluding winter is learned.

The relationship specifying data DR specifies the relationship of time series data of the accelerator operation amount PA, the vehicle speed V, and the transmission ratio GR, which are state variables, with the throttle opening degree instruction value TA* and the transmission ratio instruction value GR*, which are action variables. The relationship specifying data DR is derived by reinforcement learning. In the relationship specifying data DR, the relationship specifying data DR11 is derived by performing reinforcement learning based on an assumption that the vehicles travel in the first area AR1 in seasons excluding winter. The relationship specifying data DR12 is derived by performing reinforcement learning based on an assumption that the vehicles travel in the first area AR1 in winter. The relationship specifying data DR21 is derived by performing reinforcement learning based on an assumption that the vehicles travel in the second area AR2 in seasons excluding winter.

In the present embodiment, when actually running the internal combustion engine 10, a state s is obtained, and the relationship specifying data DR is updated based on the obtained state s. When running the internal combustion engine 10 as described above, the internal combustion engine 10 is supplied with fuel corresponding to the relationship specifying data DR that is updated. For example, when the environment variable VA is “11,” the internal combustion engine 10 runs using fuel having the same property as the fuel supplied to the vehicle from a fueling station in the first area AR1 in a season excluding winter. For example, when the environment variable VA is changed from “11” to “12,” the fuel supplied to the internal combustion engine 10 is changed, that is, the internal combustion engine 10 is supplied with fuel having the same property as the fuel supplied to the vehicle from a fueling station in the first area AR1 in winter. Subsequently, the internal combustion engine 10 runs.

While the internal combustion engine 10 is running, the CPU 112 obtains time series data including six sampling values “PA(1), PA(2), . . . PA(6)” of the accelerator operation amount PA, the present transmission ratio GR, and the vehicle speed V as the state s (S12). The sampling values of time series data are sampled at different points in time. In the present embodiment, the time series data includes six sampling values that are sampled in a fixed sampling period and are consecutive on a time-series basis. However, the system shown in FIG. 3 does not include the accelerator pedal 86. Hence, the generator 110 simulates the state of the vehicle VC1 to generate a simulated accelerator operation amount PA. The simulated accelerator operation (e.g. depression) amount PA is used as a state of the vehicle based on a detection value of a sensor. In addition, the CPU 112 calculates the vehicle speed V as a traveling speed of a vehicle assuming that the vehicle actually exists. In the present embodiment, this vehicle speed V is used as a state of the vehicle based on a detection value of a sensor. More specifically, the CPU 112 calculates a rotation speed NE of the crankshaft 28 based on the output signal Scr of the crank angle sensor 84, and calculates the vehicle speed V based on the rotation speed NE and the transmission ratio GR.

The CPU 112 sets an action a including the throttle opening degree instruction value TA* and the transmission ratio instruction value GR* corresponding to the state s obtained in the process of S12 in accordance with a policy π (S14). The policy π is determined by one of the relationship specifying data DR11, DR12, DR21, . . . that corresponds to the value of the environment variable VA set in the process of S12.

In the present embodiment, the relationship specifying data DR determines an action value function Q and the policy π. In the present embodiment, the action value function Q is a table-type function indicating values of expected return corresponding to a ten-dimensional independent variable of the action a and the state s. When a state s is given, while giving priority to selecting the maximum action a (greedy action) in the action value function Q with the independent variable corresponding to the given state s, the policy π sets a rule of selecting another action a at a predetermined probability.

More specifically, in the present embodiment, the number of possible values of the independent variable in the action value function Q is such that some of all combinations of possible values of the state s and the action a are eliminated based on human knowledge or the like. That is, for example, when one of two consecutive sampling values in time series data of the accelerator operation amount PA is the minimum value of the accelerator operation amount PA, the other sampling value may be the maximum value of the accelerator operation amount PA. Such sampling values cannot be obtained when the accelerator pedal 86 is manually operated and thus are not defined in the action value function Q. In addition, to avoid a quick change in the transmission ratio GR from the second speed to the fourth speed, for example, when the present transmission ratio GR corresponds to the second speed, the transmission ratio instruction value GR* as a possible action a is limited to the first speed, the second speed, and the third speed. That is, when the transmission ratio GR as the state s corresponds to the second speed, the action a is not defined for the fourth or higher speeds. In the present embodiment, the dimensions are reduced based on the human knowledge or the like so that possible values of the independent variable defining the action value function Q are limited to the fifth power of ten or less, and more desirably, the fourth power of ten or less.

The CPU 112 transmits the operating signal MS1 to the throttle valve 14 to operate the throttle opening degree TA based on the throttle opening degree instruction value TA* and the transmission ratio instruction value GR* that have been set, and transmits the operating signal MS5 to the transmission 50 to operate the transmission ratio (S16). The CPU 112 obtains the rotation speed NE, the transmission ratio GR, torque Trq of the internal combustion engine 10, a torque instruction value Trq* of the internal combustion engine 10, and the acceleration rate Gx (S18). The CPU 112 calculates the torque Trq based on a load torque generated by the dynamometer 100 and the transmission ratio of the transmission 50. The torque instruction value Trq* is set in accordance with the accelerator operation amount PA and the transmission ratio GR. In this embodiment, since the transmission ratio instruction value GR* is an action variable of reinforcement learning, the transmission ratio instruction value GR* may not limit the torque instruction value Trq* to be less than or equal to the maximum torque achievable by the internal combustion engine 10. Hence, the torque instruction value Trq* is not limited to a value that is less than or equal to the maximum torque achievable by the internal combustion engine 10. The CPU 112 also calculates the acceleration rate Gx, based on the load torque of the dynamometer 100, as a value that the vehicle is assumed to obtain if the internal combustion engine 10 is mounted on the vehicle. That is, in the present embodiment, although the acceleration rate Gx is a theoretical value, the acceleration rate Gx is used as a state of the vehicle based on a detection value of a sensor.

The CPU 72 determines whether a predetermined period has elapsed from the later one of the point in time of executing the process of S10 and the point in time of executing the process S22 (S20). The process of S22 will be described later. If it is determined that the predetermined period has elapsed (S20: YES), the CPU 112 updates the relationship specifying data DR through reinforcement learning (S22).

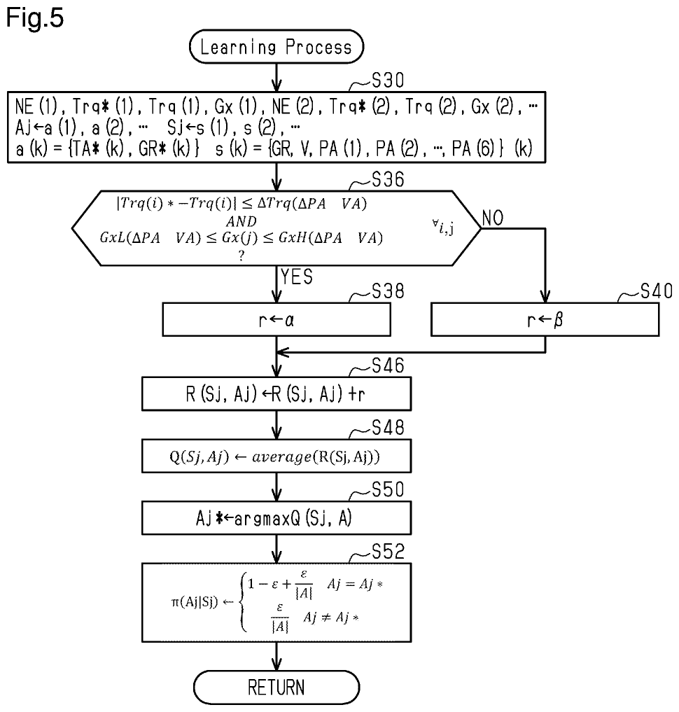

FIG. 5 shows details of the process of S22.

In a series of the processes shown in FIG. 5, in a predetermined period, the CPU 112 obtains time series data including sets of four sampling values, namely, the rotation speed NE, the torque instruction value Trq*, the torque Trq, and the acceleration rate Gx, and also obtains time series data of the state s and the action a (S30). In FIG. 5, elements having different numerals in parentheses indicate values of a variable sampled at different times. For example, the torque instruction value Trq*(1) and the torque instruction value Trq*(2) are sampled at different points in time. Time series data of the action a in the predetermined period is defined as an action set Aj. Time series data of the state s in the predetermined period is defined as a state set Sj.

The CPU 112 determines whether the logical conjunction of conditions (A) and (B) is true (S36). Condition (A) is that the absolute value of a difference between any torque Trq and the torque instruction value Trq* in a predetermined period is less than or equal to a specified amount ΔTrq. Condition (B) is that the acceleration rate Gx is greater than or equal to a lower limit value G×L and less than or equal to an upper limit value G×H.

The CPU 112 variably sets the specified amount ΔTrq in accordance with the value of the environment variable VA and a change amount ΔPA of the accelerator operation amount PA per unit time at the time of starting an episode. More specifically, when the absolute value of the change amount ΔPA is relatively large, the CPU 112 determines that the episode is related to a transition state and sets the specified amount ΔTrq to a greater value than when the episode is related to a steady state.

The CPU 112 variably sets the lower limit value G×L in accordance with the change amount ΔPA of the accelerator operation amount PA at the time of starting an episode. That is, when the episode is related to the transition state and the change amount ΔPA is a positive value, the CPU 112 sets the lower limit value G×L to a greater value than when the episode is related to the steady state. When the episode is related to the transition state and the change amount ΔPA is a negative value, the CPU 112 sets the lower limit value G×L to a smaller value than when the episode is related to the steady state.

The CPU 72 variable sets the upper limit value G×H in accordance with the change amount ΔPA of the accelerator operation amount PA per unit time at the time of starting an episode. That is, when the episode is related to the transition state and the change amount ΔPA is a positive value, the CPU 72 sets the upper limit value G×H to a greater value than when the episode is related to the steady state. When the episode is related to the transition state and the change amount ΔPA is a negative value, the CPU 72 sets the upper limit value G×H to a smaller value than when the episode is related to the steady state.

The CPU 112 variably sets the lower limit value G×L and the upper limit value G×H in accordance with the value of the environment variable VA. For example, there is a need for a higher fuel efficiency in the first area AR1 than in the second area AR2. The fuel efficiency of the vehicle is likely to increase as occurrence of quick changes in the acceleration rate Gx is limited. Therefore, the CPU 112 sets the lower limit value G×L and the upper limit value G×H, for example, so that when updating the relationship specifying data DR11 and DR12 for the first area AR1, the difference between the lower limit value G×L and the upper limit value G×H is smaller than when updating the relationship specifying data DR21 for the second area AR2.

If it is determined that the logical conjunction is true (S36: YES), the CPU 72 sets a reward r to a positive value (S38). If it is determined that the logical conjunction is false (S36: NO), the CPU 72 sets the reward r to a negative value β (S40). The processes of S36 to S40 assign a greater reward when a predetermined criterion is met than when the predetermined criterion is not met. In the present embodiment, the predetermined criterion is changed in accordance with the value of the environment variable VA.

Upon completion of the process S38 or S40, the CPU 112 updates the relationship specifying data DR. In the present embodiment, an s-soft on-policy Monte Carlo method is used.

More specifically, the CPU 112 adds the reward r to each return R(Sj, Aj) determined by a combination of each state and its corresponding action retrieved in S30 (S46). “R(Sj, Aj)” collectively refers to a return R when one of the elements in the state set Sj is used as the state and one of the elements in the action set Aj is used as the action. The CPU 112 averages the returns R(Sj, Aj) determined by combinations of each state and the corresponding action retrieved in S30 and assigns the average to the corresponding action value function Q(Sj, Aj) (S48). The averaging may be a process that divides the return R calculated in S48 by the number of times the process of S48 was executed. The initial value of the return R may be zero.

For each state retrieved in S30, the CPU 112 assigns an action including a combination of the throttle opening degree instruction value TA* and the transmission ratio instruction value GR* corresponding to the maximum value in the corresponding action value function Q(Sj, A) to an action Aj* (S50). In this description, “A” indicates any possible action. Although the action Aj* has different values in accordance with the type of state retrieved in S30, the presentation is simplified and denoted by the same symbol.

For each state retrieved in S30, the CPU 112 updates the corresponding policy π(Aj|Sj) (S52). More specifically, when the total number of actions is denoted by “|A|,” the selection probability of the action Aj* selected by S52 is expressed as “(1−ϵ)+ϵ/|A|.” The selection probability of each action other than the action Aj* is expressed as “ϵ/|A|.” The number of actions other than the action Aj* is “|A|−1.” The process of S52 is based on the action value function Q that is updated in S48. Thus, the relationship specifying data DR, which specifies the relationship between the state s and the action a, is updated to increase the return R.

Upon completion of the process of S52, the CPU 112 temporarily ends the series of the processes shown in FIG. 5.

Referring again to FIG. 4, upon completion of the process of S22, the CPU 112 determines whether the action value function Q has converged (S24). In this step, when an update amount of the action value function Q in the process of S22 is consecutively less than or equal to a predetermined value for a predetermined number of times, it may be determined that the action value function Q has converged. When it is determined that the action value function Q has not converged (S24: NO) or a negative determination is made in S20, the CPU 112 returns to S12. When it is determined that the action value function Q has converged (S24: YES), the CPU 112 determines whether a termination condition is satisfied (S26). In the present embodiment, the termination condition includes a condition that an affirmative determination is made in S24 for all of the relationship specifying data DR.

When the termination condition is not satisfied (S26: NO), the CPU 112 returns to S10 and changes the environment variable VA. For example, when the environment variable VA is “11” and the update of the relationship specifying data DR11 is completed, the CPU 112 changes the environment variable VA from “11” to “12.” When the termination condition is satisfied (S26: YES), the CPU 112 generates the map data DM based on the relationship specifying data DR. More specifically, the CPU 112 generates the map data DM as data in which the state s is associated with the value of the action variable that maximizes an expected return so that when the state s is input, the value of the action variable that maximizes the expected return is output. In this case, the CPU 112 generates the map data DM11 based on the relationship specifying data DR11 and generates the map data DM12 based on the relationship specifying data DR12. The CPU 112 generates the map data DM21 based on the relationship specifying data DR21. The CPU 112 stores the generated map data DM in the storage device 116. When the storing of the map data DM is completed, the CPU 112 temporarily ends the series of the processes shown in FIG. 4.

In the present embodiment, the storage device 136 of the server 130 stores the map data DM, that is, the map data DM11, DM12, DM21, . . . , generated by reinforcement learning through execution of the series of the processes shown in FIG. 4. That is, the server 130 is configured to provide the map data DM generated in the generator 110 to the vehicles VC1, VC2, . . . configured to communicate with the server 130.

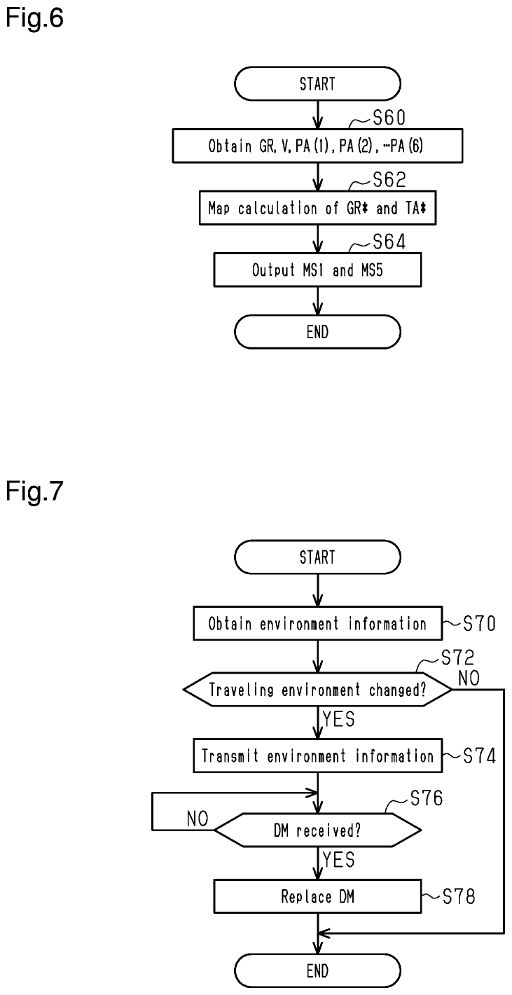

FIG. 6 shows the procedures of a process executed by the controller 70 for controlling the vehicle VC1. A series of the processes shown in FIG. 6 is implemented by the CPU 72, for example, repeatedly executing the control program 74a stored in the ROM 74 in a predetermined cycle.

In a series of the processes shown in FIG. 6, in the same manner as the process of S12 shown in FIG. 4, the CPU 72 obtains time series data including six sampling values “PA(1), PA(2), . . . PA(6)” of the accelerator operation amount PA, the present transmission ratio GR, and the vehicle speed V (S60). The CPU 72 executes map calculation for the throttle opening degree instruction value TA* and the transmission ratio instruction value GR* using the map data DM stored in the storage device 76 (S62). For example, when the map data DM11 is stored in the storage device 76 as the map data DM, the CPU 72 executes map calculation using the map data DM11. When the map data DM21 is stored in the storage device 76 as the map data DM, the CPU 72 executes map calculation using the map data DM21. For example, when the value of an input variable matches any value of an input variable in the map data DM, the map calculation may use the corresponding value of an output variable in the map data DM as the calculation result. When the value of the input variable does not match any value of the input variable in the map data DM, the map calculation may use a value obtained by interpolating multiple values of the output variable included in the map data DM set as the calculation result.

The CPU 72 transmits the operating signal MS1 to the throttle valve 14 to operate the throttle opening degree TA and transmits the operating signal MS5 to the transmission 50 to operate the transmission ratio (S64). In the present embodiment, the throttle opening degree TA is feedback-controlled to the throttle opening degree instruction value TA*. This causes operating signals MS1 to differ from each other even when the throttle opening degree instruction value TA* is the same value. When the process of S64 is completed, the CPU 72 temporarily ends the series of the processes shown in FIG. 6.

In the present embodiment, it is determined whether the traveling environment of the vehicle VC1 is changed. If it is determined that the traveling environment is changed, environment information, that is, information related to the current traveling environment of the vehicle VC1, is transmitted to the server 130. When the vehicle VC1 receives the map data DM corresponding to the current traveling environment, the received map data DM is stored in the storage device 76 of the controller 70 of the vehicle VC1. FIG. 7 shows the procedures of a process executed by the controller 70 for implementing the processes described above. A series of the processes shown in FIG. 7 is implemented by the CPU 72 executing the control program 74a stored in the ROM 74. Execution of the series of the processes shown in FIG. 7 is triggered by, for example, detection of a user seated in a seat of the vehicle VC1.

In the series of the processes shown in FIG. 7, the CPU 72 obtains environment information of the vehicle VC1 (S70). The traveling environment of the vehicle VC1 includes the current position information of the vehicle VC1, more specifically, includes both the current travel area of the vehicle VC1 and the current season. That is, the environment information of the vehicle VC1 includes the current position information of the vehicle VC1 and information related to the season. For example, the CPU 72 obtains the position data Pgps to obtain a position on the map in the cartograph data DG indicated by the position data Pgps as the position information of the vehicle VC1. Also, for example, the CPU 72 obtains information specifying the current season or the current date as the information related to the season.

Then, the CPU 72 determines whether the traveling environment of the vehicle VC1 is changed (S72). Whether the environment information is changed is determined by comparing the position information and the season that are indicated by the environment information obtained during the previous execution of the processes shown in FIG. 7 with the position information and the season that are indicated by the environment information obtained during the current execution. The position information and the season indicated by the environment information obtained in the previous execution are referred to as the previous position information and the previous season, respectively. The position information and the season indicated by the environment information obtained in the current execution are referred to as the current position information and the current season, respectively. The CPU 72 determines whether at least one of condition (C) or condition (D) is satisfied. Condition (C) is that the area indicated by the current position information differs from the area indicated by the previous position information. Condition (D) is that the current season differs from the previous season.

If neither of conditions (C) and (D) is satisfied (S72: NO), the CPU 72 determines that the environment information has not changed and ends the series of the processes shown in FIG. 7. If at least one of condition (C) or (D) is satisfied (S72: YES), the CPU 72 determines that the environment information is changed and transmits the obtained environment information to the server 130 (S74). The CPU 72 determines whether the map data DM is received as a response to the transmission (S76). If the reception is not completed (S76: NO), the CPU 72 repeats the process of S76 until the reception is completed. If the reception is completed (S76: YES), the CPU 72 stores the received map data DM in the storage device 76 (S78). When replacement of the map data DM in the storage device 76 is completed, the CPU 72 ends the series of the processes shown in FIG. 7.

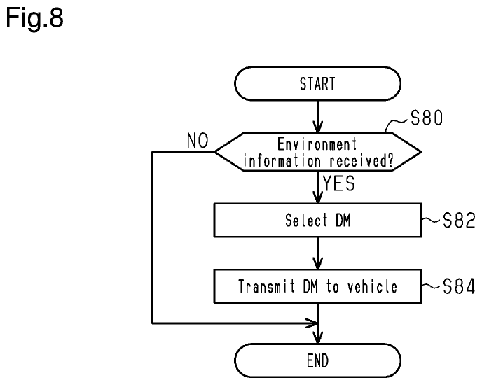

FIG. 8 shows the flow of a series of the processes executed by the server 130. A series of the processes shown in FIG. 8 is implemented by the CPU 132 executing the control program 134a stored in the ROM 134. The series of the processes is repeated while the server 130 is activated.

In the series of the processes shown in FIG. 8, the CPU 132 determines whether environment information is received from the vehicle VC1 that is configured to communicate with the server 130 (S80). If the environment information is not received (S80: NO), the CPU 132 temporarily ends the series of the processes shown in FIG. 8. If the environment information is received (S80: YES), the CPU 132 selects map data DM corresponding to the received environment information from the map data DM11, DM12, DM21, . . . stored in the storage device 136 (S82). For example, when the vehicle VC1 is traveling in the first area AR1 and the received environment information indicates that the season is winter, the CPU 132 selects the map data DM12. The CPU 132 transmits the selected map data DM to the vehicle VC1 that transmitted the environment information (S84). When the transmission of the map data DM is completed, the CPU 132 temporality ends the series of the processes shown in FIG. 8.

The operation and advantages of the present embodiment will now be described.

When it is determined that the traveling environment of the vehicle VC1 is changed, the server 130 provides the controller 70 with the map data DM corresponding to the current traveling environment. The controller 70 stores the map data DM, which is received from the server 130, in the storage device 76 and uses the map data DM to operate an electronic device of the vehicle VC1. That is, in the present embodiment, the vehicle VC1 is provided with the map data DM corresponding to the current traveling environment of the vehicle VC1, so that the controller 70 executes vehicle control in accordance with the current traveling environment.

The present embodiment further obtains the following advantages.

(1) In the present embodiment, when it is determined that the travel area of the vehicle VC1 is changed, the server 130 provides the controller 70 with the map data DM corresponding to the changed travel area. As a result, the controller 70 executes vehicle control in accordance with the current travel area.

(2) When it is determined that the season is changed, the server 130 provides the controller 70 with the map data DM corresponding to the current season, even if the travel area remains the same. As a result, the controller 70 executes vehicle control in accordance with the current season. In the present embodiment, when it is determined that both the travel area and the season are changed, the server 130 provides the controller 70 with the map data DM corresponding to the current travel area and the current season.

(3) The storage device 76 of the controller 70 stores the map data DM instead of the action value function Q. In this configuration, the CPU 72 sets the throttle opening degree instruction value TA* and the transmission ratio instruction value GR* based on map calculation using the map data DM. As a result, the calculation load on the CPU 72 is reduced as compared to a configuration in which the CPU 72 executes a process for selecting the action value function Q having the maximum value.

(4) In the present embodiment, the map data DM11, DM12, DM21, . . . are stored in the storage device 136 of the server 130. This limits an increase in the storage capacity of the controller 70 as compared to a configuration in which the map data DM11, DM12, DM21, . . . are stored in the controller 70 of the vehicle VC1.

### Second Embodiment

A second embodiment will be described below with reference to the drawings. The differences from the first embodiment will mainly be discussed.

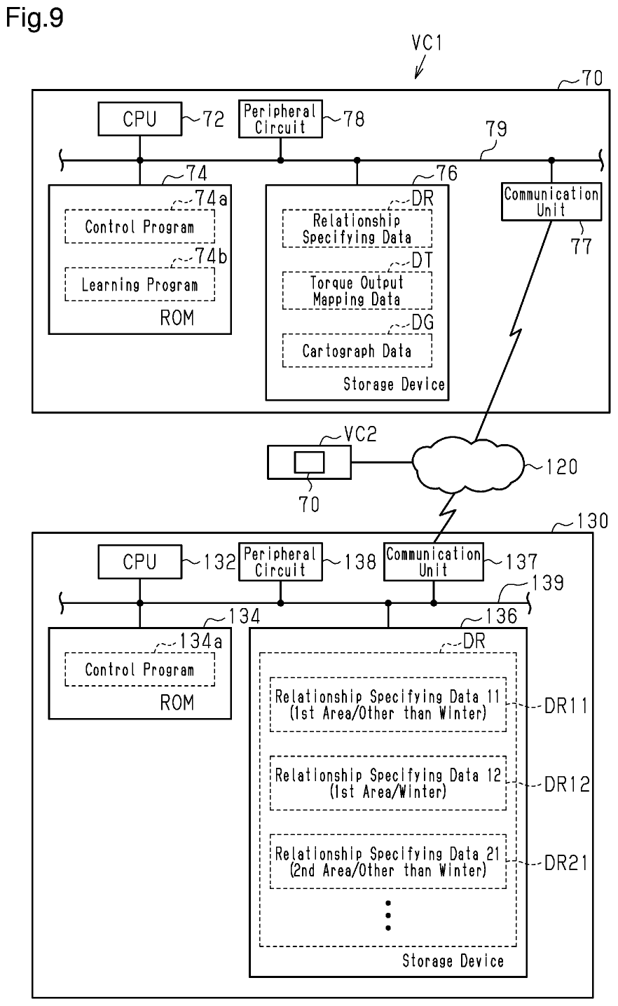

As shown in FIG. 9, in the present embodiment, the storage device 76 of the controller 70 of the vehicle VC1 stores the relationship specifying data DR and the torque output mapping data DT instead of the map data DM. The ROM 74 stores a learning program 74b in addition to the control program 74a. The learning program 74b is used to learn the relationship specifying data DR through reinforcement learning.

The torque output mapping data DT specifies a torque output mapping, which is data related to a learned model such as a neural network that uses the rotation speed NE, charging efficiency η, and an ignition timing as inputs to output the torque Trq. For example, when the process shown in FIG. 4 is executed, the torque output mapping data DT may be obtained by learning the torque Trq obtained in the process of S18 as training data. The charging efficiency η may be calculated by the CPU 72 based on the rotation speed NE and the intake air amount Ga.

The storage device 136 of the server 130 stores the relationship specifying data DR11, DR12, DR21, . . . as the relationship specifying data DR. Each of the relationship specifying data DR11, DR12, DR21, . . . stored in the storage device 136 is relationship specifying data derived in the processes shown in FIGS. 4 and 5.

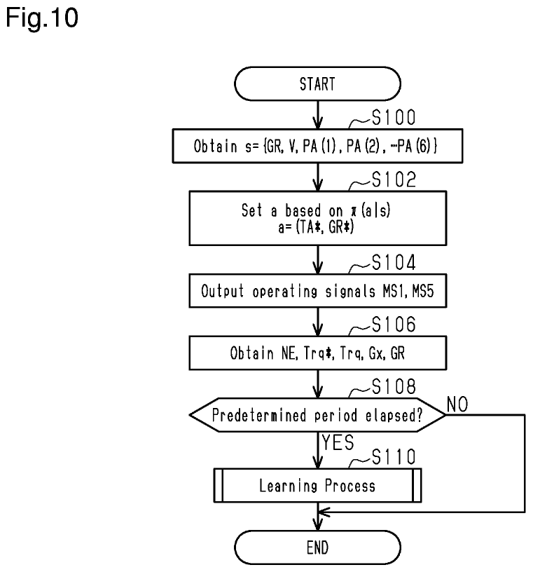

FIG. 10 shows the procedures of a process executed by the controller 70 of the vehicle VC1 when updating the relationship specifying data DR stored in the storage device 76 while operating the electronic device of the vehicle VC1. A series of the processes shown in FIG. 10 is implemented by the CPU 72 executing the control program 74a and the learning program 74b stored in the ROM 74. The series of the processes is repeated while the internal combustion engine 10 is running.

In the series of the processes shown in FIG. 10, the CPU 72 obtains time series data of the accelerator operation amount PA, the present transmission ratio GR, and the vehicle speed V as the state s (S100). In the same manner as S14 shown in FIG. 4, the CPU 72 sets the action a including the throttle opening degree instruction value TA* and the transmission ratio instruction value GR* corresponding to the state s obtained in the process of S100 (S102). The CPU 112 transmits the operating signal MS1 to the throttle valve 14 to operate the throttle opening degree TA based on the throttle opening degree instruction value TA* and the transmission ratio instruction value GR* that have been set, and transmits the operating signal MS5 to the transmission 50 to operate the transmission ratio (S104). The CPU 112 obtains the rotation speed NE, the transmission ratio GR, the torque Trq of the internal combustion engine 10, the torque instruction value Trq* of the internal combustion engine 10, and the acceleration rate Gx (S106). The CPU 72 calculates the torque Trq by inputting the rotation speed NE, the charging efficiency η, and the ignition timing to the torque output mapping. The CPU 72 sets the torque instruction value Trq* in accordance with the accelerator operation amount PA.

In the same manner as S20 shown in FIG. 4, the CPU 112 determines whether a predetermined period has elapsed from the point in time of executing the process of S110, which will be described later (S108). If it is determined that the predetermined period has elapsed (S108: YES), the CPU 112 updates the relationship specifying data DR through reinforcement learning (S110). If it is determined that the predetermined period has not elapsed (S108: NO), the CPU 72 temporarily ends the series of the processes shown in FIG. 10.

The process of S110 shown in FIG. 10 is the same as the series of the processes shown in FIG. 5. The specific process of S110 shown in FIG. 10 will not be described.

In the present embodiment, when a series of the processes shown in FIG. 10 is executed and the vehicle VC1 travels, if it is determined that the traveling environment of the vehicle VC1 is changed as an affirmative determination is made in S72 shown in FIG. 7, the current environment information is transmitted to the server 130 in the same manner as S74 shown in FIG. 7. When the server 130 receives the environment information from the vehicle VC1 as an affirmative determination is made in S80 shown in FIG. 8, the server 130 selects data from the data stored in the storage device 136 in the same manner as S82 shown in FIG. 8. However, in the present embodiment, relationship specifying data DR corresponding to the current traveling environment of the vehicle VC1 is selected from the relationship specifying data DR stored in the storage device 136. The server 130 transmits the selected data to the vehicle VC1 in the same manner as S84 shown in FIG. 8. However, in the present embodiment, the relationship specifying data DR is transmitted to the vehicle VC1. The vehicle VC1 stores the data received from the server 130 in the storage device 76 in the same manner as S78 shown in FIG. 7. However, in the present embodiment, the relationship specifying data DR received from the server 130 is stored in the storage device 76.

In the present embodiment, the controller 70 of the vehicle VC1 includes the relationship specifying data DR and the learning program 74b. After the vehicle VC1 receives the relationship specifying data DR corresponding to the current traveling environment from the server 130, the vehicle VC1 continues to update the relationship specifying data DR. This allows the vehicle control to further approach control corresponding to the current traveling environment.

### Third Embodiment

A third embodiment will be described below with reference to the drawings. The differences from the second embodiment will mainly be discussed.

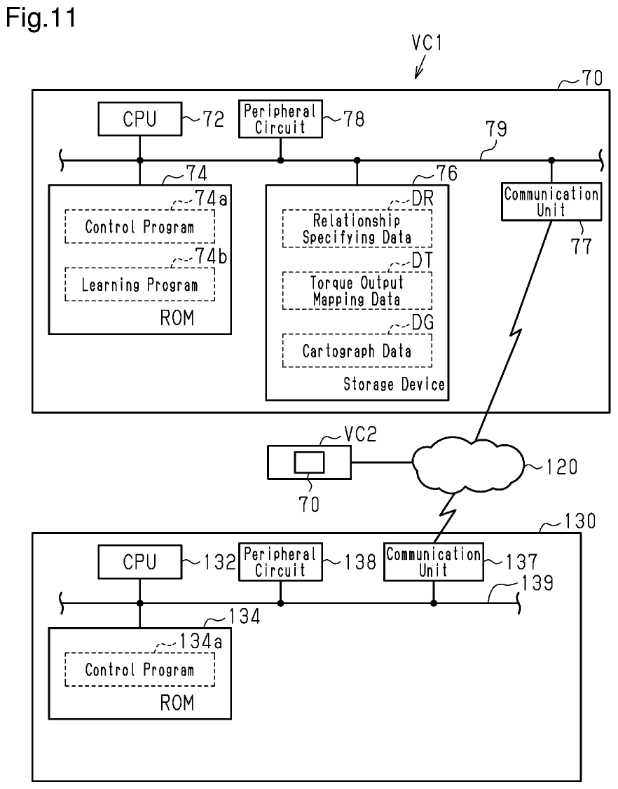

As shown in FIG. 11, the present embodiment differs from the second embodiment in that the relationship specifying data DR is not stored in the server 130.

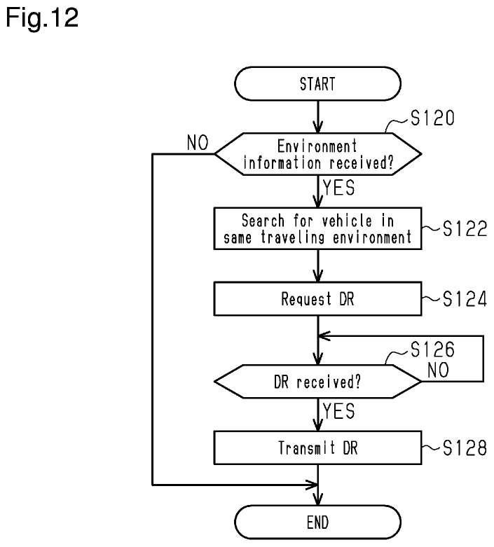

When the server 130 receives the environment information of the vehicle VC1 due to a change in the traveling environment of the vehicle VC1, the server 130 searches for another vehicle that is traveling in the same traveling environment as the vehicle VC1. When the searched vehicle is referred to as a searched vehicle, the relationship specifying data DR used in the searched vehicle is provided to the vehicle VC1 via the server 130. FIG. 12 shows the procedures of a process executed in the server 130 at this time. A series of the processes shown in FIG. 12 is implemented by the CPU 132 executing the control program 134a stored in the ROM 134. The series of the processes is repeated while the server 130 is activated.

In the series of the processes shown in FIG. 12, the CPU 132 determines whether environment information is received from the vehicle VC1 that is configured to communicate with the server 130 (S120). If the environment information is not received (S120: NO), the CPU 132 temporarily ends the series of the processes shown in FIG. 12. If the environment information is received (S120: YES), the CPU 132 searches for another vehicle, that is, the searched vehicle, traveling in the same traveling environment as that indicted by the environment information received from the vehicle VC1 among vehicles configured to communicate with the server 130 (S122). There may be a number of vehicles that are found in the process of S122, that is, vehicles that are determined to be traveling in the same traveling environment as the vehicle VC1. In such a case, the CPU 132 selects one from the vehicles satisfying the condition as the searched vehicle. For example, when the current traveling environment of the vehicle VC1 is a certain traveling environment, the CPU 132 selects the vehicle that has been traveling in the certain traveling environment for the longest time as the searched vehicle. This is based on an assumption that the updating of the relationship specifying data DR is advanced as the travel time increases.

The CPU 132 requests the controller 70 of the searched vehicle to transmit the relationship specifying data DR used in the searched vehicle (S124). Then, the CPU 132 determines whether the relationship specifying data DR of the searched vehicle is received from the searched vehicle (S126). If the reception is not completed (S126: NO), the CPU 132 repeats the process of 5126 until the reception is completed. If the reception is completed (S126: YES), the CPU 132 transmits the relationship specifying data DR of the searched vehicle to the vehicle VC1 that transmitted the environment information (S128). When the transmission of the relationship specifying data DR is completed, the CPU 132 temporality ends the series of the processes shown in FIG. 12.

More specifically, in the present embodiment, when it is determined that the traveling environment of the vehicle VC1 is changed as an affirmative determination is made in S72 shown in FIG. 7, the server 130 receives the relationship specifying data DR of the vehicle, that is, the searched vehicle, traveling in the same traveling environment as the vehicle VC1 from the searched vehicle (S122 to S126 shown in FIG. 12). The relationship specifying data DR of the searched vehicle is transmitted to the vehicle VC1 (S128 shown in FIG. 12). In the same manner as the process of S76 shown in FIG. 7, the vehicle VC1 receives data from the server 130. However, in the present embodiment, the relationship specifying data DR of another vehicle (searched vehicle) traveling in the environment that is same as the current traveling environment of the vehicle VC1 is received. The vehicle VC1 stores the data received from the server 130 in the storage device 76 in the same manner as S78 shown in FIG. 7. However, in the present embodiment, the relationship specifying data DR of the searched vehicle is stored in the storage device 76. Subsequently, the electronic device of the vehicle VC1 is operated based on the relationship specifying data DR newly stored in the storage device 76.

The searched vehicle is traveling in the traveling environment corresponding to the changed traveling environment of the vehicle VC1. That is, in the controller 70 of the searched vehicle, reinforcement learning is advanced in the traveling environment. When the relationship specifying data DR of the searched vehicle is used to operate the electronic device of the vehicle VC1, appropriate vehicle control is executed in the vehicle VC1 in accordance with the current traveling environment.

In addition, in this case, there is no need to store the relationship specifying data DR in the server 130. This limits an increase in the storage capacity of the server 130.

Correspondence Relationship

Correspondence relationship between the items in the embodiments described above and the items described in “SUMMARY” is as follows. Hereinafter, the correspondence relationship is shown with each number of the aspects described in “SUMMARY.”

[1] to [3] The vehicle controller corresponds to the controller 70 shown in FIG. 2. The server corresponds to the server 130 shown in FIG. 2. The first storage device corresponds to the storage device 76 shown in FIGS. 2 and 9. The execution device, that is, the processing circuitry, includes the CPU 72 and the ROM 74 and the CPU 132 and the ROM 134 shown in FIGS. 2 and 9. The state obtaining process corresponds to S60 shown in FIGS. 6 and S100 and S106 shown in FIG. 10. The operating process corresponds to S64 shown in FIGS. 6 and S104 shown in FIG. 10. The environment determination process corresponds to S72 shown in FIG. 7. The data changing process includes S76 and S78 shown in FIGS. 7 and S82 and S84 shown in FIG. 8. The operating data stored in the first storage device corresponds to the map data DM stored in the storage device 76 shown in

FIG. 2 and corresponds to the relationship specifying data DR stored in the storage device 76 shown in FIG. 9.

[4] The relationship specifying data corresponds to the relationship specifying data DR stored in the storage device 76 shown in FIGS. 9.

[4] and [5] The update mapping corresponds to a mapping specified by an instruction to execute the processes of S46 to S52 shown in FIG. 5 in the learning programs 114a and 74b.

[5] The control mapping data corresponds to the map data DM stored in the storage device 76 shown in FIG. 2.

[6] The second storage device correspond to the storage device 136 shown in FIGS. 2 and 9. The operating data stored in the second storage device correspond to the map data DM11, DM12, DM21, . . . stored in the storage device 136 shown in FIG. 2 and correspond to the relationship specifying data DR11, DR12, DR21, . . . stored in the storage device 136 shown in FIG. 9. The data selection process corresponds to S82 shown in FIG. 8. The transmission process corresponds to S84 shown in FIG. 8. The data storing process corresponds to S76 and S78 shown in FIG. 7.

[7] The vehicle search process corresponds to S122 shown in FIG. 12. The changing data obtaining process corresponds to S124 and S126 shown in FIG. 12. The data storing process includes S128 shown in FIGS. 12 and S76 and S78 shown in FIG. 7. The first vehicle corresponds to the vehicle VC1. The second vehicle corresponds to the searched vehicle.

[8] and [9] The first execution device corresponds to the CPU 72 and the ROM 74 shown in FIGS. 2 and 9.

[8] and [10] The second execution device corresponds to the CPU 132 and the ROM 134 shown in FIGS. 2 and 9.

### MODIFIED EXAMPLES

The embodiments may be modified as follows. The embodiments and the following modified examples can be combined as long as the combined modified examples remain technically consistent with each other.

Vehicle Traveling Environment

In each embodiment, the current travel area of the vehicle and the current season are obtained as the environment information. However, there is no limitation to such a configuration. For example, information related to only one of the current travel area of the vehicle and the current season may be obtained as the environment information.

Travel Area

In the embodiments, the areas are divided based on the difference in the property of fuel supplied to vehicles from fueling stations. However, there is no limitation to such a configuration. For example, the travel areas may be divided for each country. This is because regulations (e.g., emission regulations) may differ between countries.

Furthermore, one country may be divided by regions, and the divided regions may be used as the travel areas.

The travel areas may be divided based on each road on which the vehicle is traveling. The travel areas may be divided based on, for example, a general road and a relatively high speed road such as an expressway. This is because the way the vehicle travels may differ between the general road and the expressway. On the expressway, the vehicle often travels at a relatively high constant speed. On the genera road, the vehicle often increases and decreases the speed while traveling.

Dimensionality Reduction of Tabular Data

A process for reducing the dimensions of tabular data is not limited to that described in the embodiments. For example, since the accelerator operation amount PA rarely reaches the maximum value, the action value function Q may be configured not to be defined for a state in which the accelerator operation amount PA is greater than or equal to the specified amount. The throttle opening degree instruction value TA* and the like may be separately adapted for the state in which the accelerator operation amount PA is greater than or equal to the specified amount. For example, the dimensions may be reduced by omitting values from possible values of the action corresponding to the throttle opening degree instruction value TA* being greater than or equal to a specified value.

Relationship Specifying Data

In the embodiments, the action value function Q is of a table-type. However, there is no limitation to such a configuration. For example, a function approximator may be used.

For example, instead of using the action value function Q, the policy 7π may be expressed by a function approximator in which the state s and the action a are independent variables and the probability of the action a is a dependent variable. A parameter that determines the function approximator may be updated in accordance with the reward r. In this case, separate function approximators may be provided for values of the environment variable VA. Alternatively, for example, the environment variable VA may be included in the state s as an independent variable of a single function approximator.

Operating Data

The operating data may differ from the relationship specifying data DR and the control mapping data as long as the data is used to derive an operation instruction value of the electronic device of the vehicle VC1. The operating data may be, for example, data that is updated by a learning process different from reinforcement learning.

In the first and second embodiments, the number of operating data stored in the second storage device may be any number that is greater than or equal to two.

Operating Process

For example, as described in “Relationship Specifying Data,” when the action value function is a function approximator, the action a that maximizes the action value function Q may be specified by inputting the state s and all combinations of discrete values of the action used as an independent variable of the table-type function in the embodiments into the action value function Q. In this case, for example, while using mainly the specified action a for operation, other actions may be selected at a predetermined probability.

For example, as described in “Relationship Specifying Data,” when the policy π is a function approximator in which the state s and the action a are independent variables and the probability of the action a is a dependent variable, the action a may be selected based on the probability shown by the policy π.

Data Changing Process

In an embodiment such as the first embodiment in which the vehicle is provided with the map data DM corresponding to the environment information, for example, a case in which information related to only the travel area of the vehicle is obtained as the environment information will now be considered as described in “Vehicle Traveling Environment.” In this case, for example, a first vehicle in which map data for the first area AR1 is prestored in the storage device 76 may be sold in the first area AR1, and a second vehicle in which map data for the second area AR2 is prestored in the storage device 76 may be sold in the second area AR2. When the travel area of the first vehicle is changed from the first area AR1 to the second area AR2, the server 130 may receive map data for the second area AR2 from the second vehicle and provide the first vehicle with the map data for the second area AR2 received from the second vehicle. This configuration eliminates the need for storing a large number of map data in the storage device 136 of the server 130.

Update Mapping

In the processes of S46 to S52, an ϵ-soft on-policy Monte Carlo method is used. However, there is no limitation to such a configuration. For example, an off-policy Monte Carlo method may be used. Moreover, there is no limitation to a Monte Carlo method. For example, an off-policy temporal difference (TD) method may be used. An on-policy TD method such as a state-action-reward-state-action (SARSA) method may be used. An eligibility trace method may also be used as on-policy learning.

For example, as described in “Relationship Specifying Data,” the policy π may be expressed using a function approximator. When the policy π is directly updated based on the reward r, a policy gradient method may be used to configure the update mapping.

The subject that is directly updated by the reward r is not limited to only one of the action value function Q and the policy π. For example, as an actor-critic method, each of the action value function Q and the policy π may be updated. Further, in the actor-critic method, for example, a value function may be updated instead of the action value function Q.

Action Variable

In the embodiments, the throttle opening degree instruction value TA* is used as the action variable related to the opening degree of the throttle valve. However, there is no limitation to such a configuration. For example, the responsiveness of the throttle opening degree instruction value TA* to the accelerator operation amount PA may be expressed in a waste time and a secondary delay filter. Two variables specifying the waste time and the secondary delay filter may be added, and the three variables may be used as the variables related to the opening degree of the throttle valve. In this case, the state variable may be an amount of change in the accelerator operation amount PA per unit time instead of the time series data of the accelerator operation amount PA.

In the embodiments, the variable related to the opening degree of the throttle valve and the variable related to the transmission ratio are used as the action variables. However, there is no limitation to such a configuration. For example, in addition to the variable related to the opening degree of the throttle value and the variable related to the transmission ratio, a variable related to ignition timing and a variable related to air-fuel ratio control may be used.

As described below in “Internal Combustion Engine”, when the internal combustion engine is of a compression ignition type, a variable related to an injection amount may be used instead of the variable related to the opening degree of the throttle valve. In addition, for example, a variable related to injection timing, a variable related to the number of injections performed in one combustion cycle and a variable related to a time interval between the end time and the start time of two fuel injections for one cylinder that are adjacent on a time-series basis in one combustion cycle may be used.

For example, when the transmission 50 is a multi-speed transmission, the action variable may include a current value of a solenoid valve that hydraulically adjusts the engagement state of a clutch.

As described below in “Electronic Device”, when a subject of operation corresponding to an action variable includes a rotary electric machine, the action variable may include torque or electric current of the rotary electric machine. More specifically, a load variable, which is a variable related to the load of a propulsive force generator, may be the torque or electric current of the rotary electric machine instead of the variable related to the opening degree of the throttle valve and the injection amount.

As described in “Electronic Device”, when a subject of operation corresponding to an action variable includes the lock-up clutch 42, the action variable may include a variable indicating an engagement state of the lock-up clutch 42. When the action variable includes the engagement state of the lock-up clutch 42, changing the value of the action variable in accordance with the priority level of a requirement for increasing the energy usage efficiency is particularly advantageous.

Method for Generating Vehicle Controlling Data

In the process of S14 in FIG. 4, the action is set based on the action value function Q. Instead, all possible actions may be selected at an equal probability.

Control Mapping Data

Control mapping data associates the state of the vehicle with the value of the action variable that maximizes an expected return in a one-to-one relationship so that when a state of the vehicle is input, the value of the action variable that maximizes the expected return is output. The control mapping data is not limited to map data. For example, a function approximator may be used. For example, as described in “Update Mapping”, this may be implemented when a policy gradient method or the like is used by expressing the policy π in Gaussian distribution that shows the probability of a value of the action variable, expressing an average value using a function approximator, updating a parameter of the function approximator expressing the average value, and using the learned average value as control mapping data. That is, the average value that is output from the function approximator is regarded as a value of the action variable that maximizes the expected return. In this case, a separate function approximator may be arranged for each value of the environment variable VA. Alternatively, a single function approximator may be used, and the environment variable VA may be included in the state s, which is an independent variable of the function approximator.

State

In the embodiments, the time series data of the accelerator operation amount PA has six values that are sampled at equal intervals. However, there is no limitation to such a configuration. The data may have two or more sampling values that are obtained at different sampling timings. In this case, the data may have three or more sampling values or may be sampled at equal intervals.

The state variable related to the accelerator operation amount is not limited to the time series data of the accelerator operation amount PA and may be, for example, an amount of change in the accelerator operation amount PA per unit time as described in “Action Variable”.

For example, as described in “Action Variable”, when the action variable includes a current value of a solenoid valve, the state may include rotation speed of the input shaft 52 of the transmission, rotation speed of the output shaft 54, and hydraulic pressure adjusted by the solenoid valve. For example, as described in “Action Variable”, when the action variable includes torque or output of a rotary electric machine, the state may include the state of charge and the temperature of the battery. For example, as described in “Action Variable”, when the action includes a load torque of a compressor or consumed power of an air conditioner, the state may include the temperature of the passenger compartment.

Electronic Device

The operating unit of the internal combustion engine that is operated in accordance with the action variable is not limited to the throttle valve 14. For example, the ignition device 26 or the fuel injection valve 16 may be used.

The electronic device that is operated in accordance with the action variable and is used as a drive system device arranged between the propulsive force generator and the drive wheels is not limited to the transmission 50 and may be, for example, the lock-up clutch 42.

As described below in “Propulsive Force Generator”, when the propulsive force generator includes a rotary electric machine, the electronic device operated in accordance with the action variable may be a power conversion circuit such as an inverter connected to the rotary electric machine. The electronic device is not limited to a device in the on-board drive system and instead may be, for example, an on-board air conditioner. In this case, for example, when the on-board air conditioner is driven by rotational drive force of the propulsive force generator, part of drive force of the propulsive force generator is supplied to the drive wheels 60. Since the part of drive force is dependent on a load torque of the on-board air conditioner, including the action variable in the load torque of the on-board air conditioner is also advantageous. In addition, for example, even when the on-board air conditioner is configured not to use rotational drive force of the propulsive force generator, the energy usage efficiency is still affected. Adding consumption power of the on-board air conditioner to the action variable is advantageous.

Execution Device

The execution device is not limited to a device that includes the CPU and the ROM and executes the software processes. For example, a dedicated hardware circuit such as an ASIC may be provided that executes at least part of the software processing executed in the embodiments. More specifically, the execution device may have any one of the following configurations (a) to (c). Configuration (a) includes a processor that executes all of the above-described processes according to programs and a program storage device such as a ROM that stores the programs. Configuration (b) includes a processor and a program storage device that execute some of the above-described processes in accordance with the programs and a dedicated hardware circuit that executes the remaining processes. Configuration (c) includes a dedicated hardware circuit that executes all of the above-described processes. Multiple software execution devices each including a processor and a program storage device and multiple dedicated hardware circuits may be provided. More specifically, the above-described processes may be executed by processing circuitry that includes at least one of one or more software execution devices or one or more dedicated hardware circuits. The program storage device, that is, a computer readable medium, includes any medium that can be accessed from a general-purpose computer or a dedicated computer.

Internal Combustion Engine

The internal combustion engine is not limited to one including a port injection valve that injects fuel into the intake passage 12 as a fuel injection valve and may be, for example, one including a direct injection valve that directly injects fuel into the combustion chamber 24 or one including both a port injection valve and a direct injection valve.

The internal combustion engine is not limited to a spark ignition type internal combustion engine and may be, for example, a compression ignition type internal combustion engine that uses, for example, light oil as fuel.

Vehicle

The vehicle is not limited to a vehicle that includes only an internal combustion engine as the propulsive force generator of the vehicle and may be, for example, a hybrid vehicle that includes both an internal combustion engine and a rotary electric machine. The vehicle may include, for example, only a rotary electric machine as the propulsive force generator such as an electric car or a fuel cell vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle control method applied to a system including a vehicle controller arranged on a vehicle and a server configured to communicate with the vehicle controller, the vehicle controller including a first storage device configured to store operating data used when operating an electronic device of the vehicle, the vehicle control method, comprising:
executing a state obtaining process that obtains a state of the vehicle based on a detection value of a sensor arranged on the vehicle with processing circuitry;
executing an operating process that operates the electronic device based on the state of the vehicle obtained in the state obtaining process and the operating data stored in the first storage device with the processing circuitry;
executing an environment information obtaining process that obtains environment information with the processing circuitry, the environment information being information related to a traveling environment, and the traveling environment being an environment in which the vehicle is traveling;
executing an environment determination process that determines whether the traveling environment indicated by the environment information obtained in the environment information obtaining process is changed with the processing circuitry; and
when the environment determination process determines that the traveling environment is changed, executing a data changing process that causes the vehicle controller to obtain the operating data corresponding to the environment information from the server and causes the first storage device to store the operating data with the processing circuitry.

2. The vehicle control method according to claim 1, wherein
the environment information includes information related to an area in which the vehicle is traveling, and
the environment determination process includes a process that determines that the traveling environment is changed when the area in which the vehicle is traveling, indicated by the environment information, is changed.

3. The vehicle control method according to claim 1, wherein
the environment information includes information related to a current season, and
the environment determination process includes a process that determines that the traveling environment is changed when the season indicated by the environment information is changed.

4. The vehicle control method according to claim 1, wherein
the operating data includes relationship specifying data specifying a relationship between the state of the vehicle and an action variable,
the action variable is related to operation of the electronic device,
the relationship specifying data is obtained by executing
a process that assigns a reward based on the state of the vehicle when the electronic device is operated in accordance with a value of the action variable determined by the state of the vehicle and the relationship specifying data, the reward assigned when a property of the vehicle meets a predetermined criterion being greater than the reward assigned when the property of the vehicle does not meet the predetermined criterion, and
a process that updates the relationship specifying data using the state of the vehicle when the electronic device is operated, the value of the action variable used for operation of the electronic device, and the reward corresponding to the operation as inputs to a predetermined update mapping, and
the update mapping is configured to output the relationship specifying data that is updated so that an expected return of the reward is increased when the electronic device is operated in accordance with the relationship specifying data.

5. The vehicle control method according to claim 1, wherein
the operating data includes control mapping data generated based on relationship specifying data specifying a relationship between the state of the vehicle and an action variable,
the action variable is related to operation of the electronic device,
the relationship specifying data is obtained by executing
a process that assigns a reward based on the state of the vehicle when the electronic device is operated in accordance with a value of the action variable determined by the state of the vehicle and the relationship specifying data, the reward assigned when a property of the vehicle meets a predetermined criterion being greater than the reward assigned when the property of the vehicle does not meet the predetermined criterion, and
a process that updates the relationship specifying data using the state of the vehicle when the electronic device is operated, the value of the action variable used for operation of the electronic device, and the reward corresponding to the operation as inputs to a predetermined update mapping, and
the update mapping is configured to output the relationship specifying data that is updated so that an expected return of the reward is increased when the electronic device is operated in accordance with the relationship specifying data.

6. The vehicle control method according to claim 1, wherein
the server includes a second storage device configured to store multiple of the operating data corresponding to pieces of the environment information that are assumed, and
the data changing process includes
a data selection process that selects operating data that corresponds to the environment information obtained in the environment information obtaining process from the multiple of the operating data stored in the second storage device,
a transmission process that transmits the operating data selected in the data selection process to the vehicle controller, and
a data storing process that causes the first storage device to store the operating data transmitted from the server in the transmission process.

7. The vehicle control process according to claim 4, wherein
the vehicle is a first vehicle that is one of vehicles configured to communicate with the server, and
the data changing process includes
a vehicle search process that searches, when the traveling environment indicated by the environment information of the first vehicle is changed, for a second vehicle that is traveling in the traveling environment that is same as the changed traveling environment of the first vehicle,
a changing data obtaining process that causes the server to obtain the relationship specifying data of the second vehicle searched in the vehicle search process from the second vehicle,
a transmission process that transmits the relationship specifying data of the second vehicle obtained by the server in the changing data obtaining process to the first vehicle, and
a data storing process that causes the first storage device of the first vehicle to store the operating data of the second vehicle transmitted from the server to the first vehicle in the transmission process.

8. The vehicle control method according to claim 1, wherein
the processing circuitry includes a first execution device arranged on the vehicle and a second execution device arranged on the server, and
the vehicle control method, further comprising:
executing the state obtaining process and the operating process with the first execution device;
executing the environment information obtaining process with the first execution device or the second execution device; and
executing the data changing process with the first execution device and the second execution device.

9. A vehicle controller, comprising the first execution device and the first storage device according to claim 8.

10. A server, comprising the second execution device according to claim 8.
